(19) United States
(12) Patent Application Publication
(10) Pub. No.: US 2008/0267676 A1
(43) Pub. Date: Oct. 30, 2008

(54) FIXING DEVICE, COIL UNIT FOR FIXING DEVICE AND METHOD FOR MANUFACTURING OF COIL UNIT

(75) Inventors: Masanori Takai, Izunokuni-shi (JP); Satoshi Kinouchi, Shinjuku-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/741,047

(22) Filed: Apr. 27, 2007

(51) Int. Cl. G03G 15/20

(52) U.S. Cl. 399/335

(57) ABSTRACT

In a coil unit according to this invention in which an electromagnetic induction coil and a magnetic core are sealed by a coil mold, an insulating board that secures insulation between the electromagnetic induction coil and the magnetic core and that can adjust the distance between them is provided between the electromagnetic induction coil and the magnetic core.

### BACKGROUND OF THE INVENTION

1. Field of the Invention

The present invention relates to a fixing device that is loaded in an image forming apparatus such as a copy machine, printer or facsimile, and that has a heating target member that generates heat by induction heating and fixes a toner image onto a recording medium, and a coil unit used for this fixing device.

2. Description of the Related Art

As a fixing device used for an image forming apparatus such as an electrophotographic copy machine or printer, there is a device that inserts a sheet paper into a nipping part formed between a pair of rollers including a heat roller and a press roller or between a similar heat belt and a press roller and thus fixes a toner image thereon by heating and pressurizing. As a fixing device of the heating and pressurizing type, there is a fixing device that heats a heat roller or heating belt having a metal conductive layer by an induction heating system in order to increase the process speed.

In the fixing device of the induction heating system, an eddy-current is generated in the metal conductive layer of the heat roller or heat belt by a magnetic field generated by the supply of predetermined power to a coil. As this eddy-current heats the metal conductive layer in a short time, for example, the heat roller is heated. As such a fixing device of the induction heating system, there is a device in which a very thin metal conductive layer is arranged near the surface of the heat roller or heat belt and in which a coil is arranged to face the outer side of the heat roller or heat belt. In such a device, since the metal conductive layer has a small thermal capacity and the metal conductive layer is arranged near the surface, heat generation of the surface of the heat roller or heat belt can be carried out quickly.

However, in the case where the metal conductive layer with a small thermal capacity is used, the heat generation characteristic of the metal conductive layer is largely affected by the magnetic characteristic of the coil. When the magnetic characteristic of the coil changes, the heat generation characteristic of the metal conductive layer changes, too. On the other hand, when the coil is supplied with power, oscillations are generated in the coil by a high-frequency current flowing through the coil. As the coil oscillates, the positional relation between the coil and the metal conductive layer changes and the magnetic characteristic of the coil changes. This causes the heat generation characteristic of the metal conductive layer to change and may lower the fixing performance.

Thus, for example, JP-A-2003-68442 discloses a coil unit including a coil holder 1, an electromagnetic induction coil 8 and a coil holding member 2 set in an injection-molding metal mold and sealed therein with an insulating resin 3. This device prevents the electromagnetic induction coil 8 from oscillating since the coil holder 1, the electromagnetic induction coil 8 and the coil holding member 2 are sealed with the insulating resin 3.

However, in the above coil unit, the electromagnetic induction coil 8 is held by the coil holder 1, the coil holding member 2 and the insulating resin 3. That is, at least three types of metal molds are necessary to form the coil holder 1, the coil holding member 2 and the insulating resin 3, respectively. Therefore, the molding process is complicated and reduction in the cost may be hindered.

Meanwhile, recently, a coil unit is developed that is of a type in which magnetic fluxes are concentrated on a heating target member such as a heat roller by using a magnetic core shaped to be along the coil. In such a coil unit, in sealing the coil and the magnetic core with an insulating resin, a space is provided between the coil and the magnetic core and the insulating resin is injected into the space. That is, the insulating resin injected in the space insulates the coil from the magnetic core. However, in this case, the space to insulate the coil from the magnetic core must be narrower in order to improve the magnetic efficiency of the magnetic core.

Therefore, in resin sealing and molding to fix the coil, it is desired that the coil and the magnetic core are set in an injection-molding metal mold, with the space between the coil and the magnetic core being set to be narrow. However, this may cause the coil to contact the magnetic core during the resin sealing and molding. This is because the electromagnetic induction coil is deformed by the influence of the flow of liquid resin injected into the metal mold.

Then, in the resin sealing and molding, if the resin is hardened in the state where the coil is in contact with the magnetic core, insulation between the coil and the magnetic core cannot be secured. Moreover, once the coil and the magnetic core are fixed by the resin sealing and molding, insulation failure between the coil and the magnetic core, if any, cannot be corrected and it lowers the manufacturing yield of the coil unit.

Thus, in the coil unit to generate heat in the metal conductive layer by the induction heating system, when the coil is sealed and fixed with the resin in order to stabilize the heat generation characteristic of the metal conductive layer, it is desired that insulation between the coil and the magnetic core is securely provided even in the case where the coil and the magnetic core are arranged close to each other to prevent loss of the magnetic efficiency of the coil unit.

### SUMMARY OF THE INVENTION

According to an aspect of the invention, in a coil unit to generate heat in a metal conductive layer by induction heating, when an electromagnetic induction coil is sealed with a resin, the electromagnetic induction coil is securely prevented from contacting a magnetic core even if a flow of liquid resin occurs in a metal mold and deforms the electromagnetic induction coil. Thus, the coil unit with high manufacturing yield is provided. Also, a fixing device using such a coil unit is provided. According to another aspect of the invention, in the coil unit, the space between the electromagnetic induction coil and the magnetic core is made adjustable when the electromagnetic induction coil is sealed with the resin. As the space is adjusted, the coil unit having a uniform heat generating temperature of the metal conductive layer is provided. Also, a fixing device using such a coil unit is provided.

According to an embodiment of the invention, a coil unit includes a coil, a magnetic core arranged with a predetermined space to the coil, an insulating member inserted into the predetermined space between the coil and the magnetic core, a positioning holder configured to position the coil, the insulating member and the magnetic core, and a fixing member configured to harden after being molded in a liquid state and to fix the coil, the insulating member and the magnetic core, which are positioned, together with the positioning holder.

### BRIEF DESCRIPTION OF THE DRAWINGS

FIG. 1 is a schematic configuration view showing an image forming apparatus equipped with a fixing device that uses a coil unit according to a first embodiment of the invention;

FIG. 2 is a schematic configuration view showing the fixing device according to the first embodiment of the invention;

FIG. 3 is a schematic explanatory view showing the layout of a heat roller and a coil unit according to the first embodiment of the invention;

FIG. 4 is an exploded perspective view of a coil unit according to the first embodiment of the invention;

FIG. 5 is an exploded side view of a coil unit according to the first embodiment of the invention;

FIG. 6 is a schematic side view showing a state where an electromagnetic coil, an insulating board, and a magnetic core are positioned by a coil holder according to the first embodiment of the invention;

FIG. 7 is a schematic explanatory view showing injection molding of a coil mold according to the first embodiment of the invention;

FIG. 8 is a schematic side view showing a coil unit according to the first embodiment of the invention;

FIG. 9 is a schematic explanatory view showing the layout of a heat roller and a coil unit according to a second embodiment of the invention;

FIG. 10 is a schematic explanatory view showing the layout of a heat roller and a coil unit according to a third embodiment of the invention; and

FIG. 11 is a schematic explanatory view showing a gap between a coil unit and a heat roller according to a fourth embodiment of the invention.

### DETAILED DESCRIPTION OF THE PREFERRED EMBODIMENT

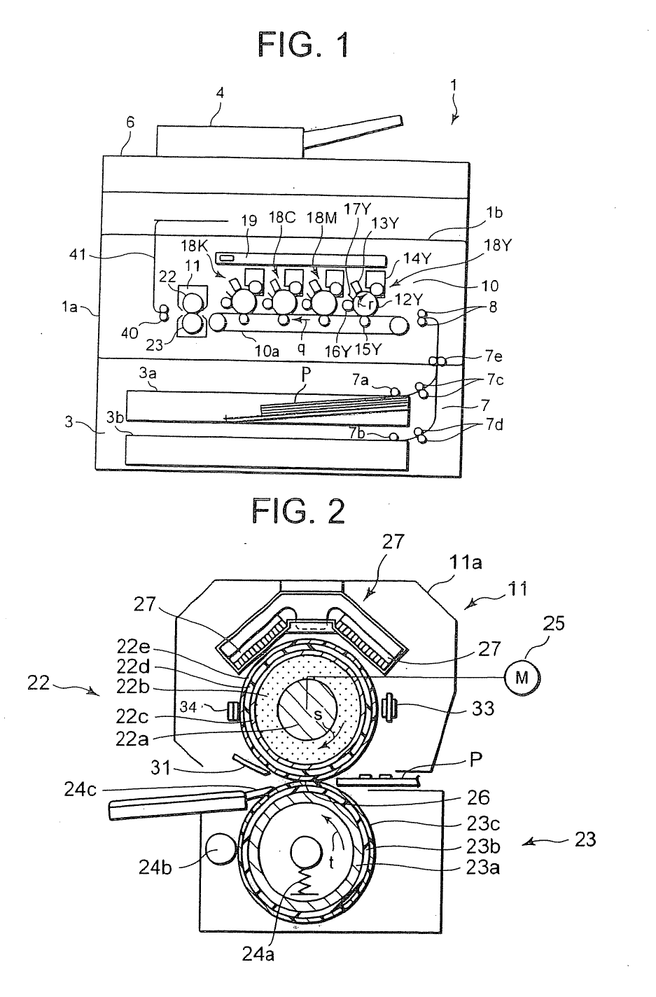

Hereinafter, a first embodiment of the invention will be described in detail with reference to the accompanying drawings. FIG. 1 is a schematic configuration view showing an image forming apparatus 1 equipped with a fixing device 11 that uses a coil unit 27 according to the first embodiment of the invention. A scanner unit 6 that reads an original supplied by an automatic document feeder 4 is provided at the top of the image forming apparatus 1. The image forming apparatus 1 has a cassette mechanism 3 that supplies a sheet paper P, which is a fixing target medium, to an image forming unit 10.

The cassette mechanism 3 has first and second paper feed cassettes 3a and 3b. In a carrier path 7 from the paper feed cassettes 3a, 3b to the image forming unit 10, pickup rollers 7a, 7b that take out a sheet paper from the paper feed cassettes 3a, 3b, separation carrier rollers 7c, 7d, carrier rollers 7e, and resist rollers 8 are provided. The fixing device 11 that fixes a toner image formed on the sheet paper P by the image forming unit 10 is provided downstream of the image forming unit 10. Paper eject rollers 40 are provided downstream of the fixing device 11, and a paper eject carrier path 41 is provided that carries the sheet paper P after the fixation to a paper eject unit lb.

The image forming unit 10 has image forming stations 18Y, 18M, 18C and 18K for the colors of yellow (Y), magenta (M), cyan (C) and black (K). The image forming stations 18Y, 18M, 18C and 18K are arrayed in tandem along a transfer belt 10a turned in the direction of an arrow q.

The yellow (Y) image forming station 18Y is configured with a charger 13Y, a developing device 14Y, a transfer roller 15Y, a cleaner 16Y and an electricity eliminator 17Y, which are process members, arranged around a photoconductive drum 12Y, which is an image carrier rotating in the direction of an arrow r. Also, a laser exposure device 19 that casts a laser beam to the photoconductive drum 12Y is provided above the yellow (Y) image forming station 18Y.

The magenta (M), cyan (C) and black (K) image forming stations 18M, 18C and 18K have a configuration similar to that of the yellow (Y) image forming station 18Y.

As a print operation is started in the image forming unit 10, in the yellow (Y) image forming station 18Y, the photoconductive drum 12Y rotates in the direction of the arrow r and is uniformly charged by the charger 13Y. Then, the photoconductive drum 12Y is irradiated by the laser exposure device 19 with exposure light corresponding to image information read by the scanner unit 6, and an electrostatic latent image is formed thereon. After that, a toner image is formed on the photoconductive drum 12Y by the developing device 14Y, and at the position of the transfer roller 15Y, the toner image is transferred onto the sheet paper P carried in the direction of the arrow q by the transfer belt 10a. After the end of the transfer, the photoconductive drum 12Y has the remaining toner removed by the cleaner 16Y, and the electricity on the surface of the photoconductive drum 12Y is eliminated by the electricity eliminator 17Y. Thus, the next printing is available.

The magenta (M), cyan (C) and black (K) image forming stations 18M, 18C and 18K carry out the image forming operation similarly to the yellow (Y) image forming station 18Y, and form a full-color toner image on the sheet paper P. After that, fixation by heating and pressurizing is carried out on the sheet paper P by the fixing device 11, which is an induction heating fixing device. After the print image is completed, the sheet paper is ejected to the paper eject unit 1b.

Next, the fixing device 11 will be described. FIG. 2 is a schematic configuration view showing the fixing device 11 of the induction heating system. The fixing device 11 has a heat roller 22, which is a heating target member, and a press roller 23, which is a pressurizing member. The heat roller 22 is driven in the direction of an arrow s by a driving motor 25. The press roller 23 is pressed in contact with the heat roller 22 by a compression spring 24a. Thus, a nipping part 26 with a predetermined width is formed between the heat roller 22 and the press roller 23. The press roller 23 follows the heat roller 22 and rotates in the direction of an arrow t.

Moreover, a coil unit 27 that causes the heat roller 22 to generate heat is arranged to face the outer side of the heat roller 22 of the fixing device 11. The coil unit 27 is attached to a frame 11a of the fixing device via an attachment unit 28 so that the coil unit 27 has a predetermined gap, for example, a gap of about 2.5 mm, to the heat roller 22. The gap between the coil unit 27 and the heat roller 22 is not limited, but it is preferred that the gap should be set within a range of 1.5 to 5.0 mm in order to satisfactorily generate heat in the heat roller 22.

Also, a stripping pawl 31 that prevents the sheet paper P after fixation from being wound, a non-contact thermistor 33 that detects the surface temperature of the heat roller 22, and a thermostat 34 that detects anomaly in the surface temperature of the heat roller 22 and interrupts heat generation, are provided over the outer circumference of the heat roller 22. A press-side stripping pawl 24c and a cleaning roller 24b are provided over the outer circumference of the press roller 23.

In the case where there is no risk of the sheet paper P being wound on the heat roller, the stripping pawl 31, the press-side stripping pawl 24 and the like need not be provided. Also, the number of non-contact thermistors 33 is arbitrary according to the need, and a required number of non-contact thermistors can be arranged at required positions in the longitudinal direction of the heat roller 22, which is the direction of the rotation axis of the heat roller 22.

The heat roller 22 includes an elastic layer 22b made of an elastic material such as foam rubber or sponge, a metal conductive layer 22c made of a conductive material such as nickel (Ni), a solid rubber layer 22d made of heat-resistant silicon rubber or the like, and a separation layer 22e, which are formed around a shaft 22a made of a material having a rigidity (hardness) that does not allow its deformation under a predetermined pressure. For example, the shaft 22a has a diameter of about 30 mm, the elastic layer 22b has a thickness of 5 mm, the metal conductive layer 22c has a thickness of 40 μm, the solid rubber layer 22d has a thickness of 200 μm, and the separation layer 22e has a thickness of 30 μm. The metal conductive layer 22c is not limited to nickel and may be made of stainless steel, aluminum, or a composite material of stainless steel and aluminum, and the like.

The press roller 23 includes a core metal 23a, with a rubber layer 23b of silicon rubber or fluorinated rubber formed around it, and a separation layer 23c applied thereon. Both the heat roller 22 and the press roller 23 are formed with a diameter of, for example, 40 mm. As the sheet paper P passes through the nipping part 26 between such heat roller 22 and press roller 23, the toner image on the sheet paper P is fixed by heating and pressurizing.

The press roller 23 may have a metal conductive layer that is heated by an electromagnetic induction coil, or may have a heating mechanism by having a built-in halogen lamp heater or the like, according to the need.

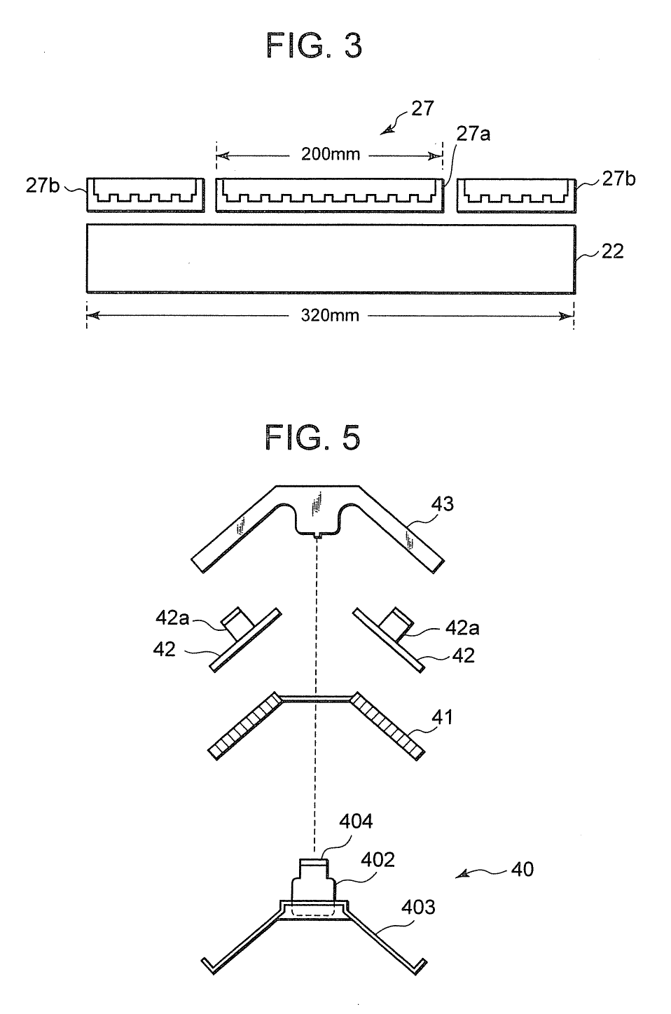

Next, the coil unit 27 will be described. As shown in FIG. 3 to FIG. 8, the coil unit 27 includes a center coil unit 27a and side coil units 27b to both sides of the center coil unit. In this embodiment, the two side coil units 27b are connected in series and are driven under the same control.

As shown in FIG. 3, the center coil unit 27a has a length of 200 mm and heats the central area of the heat roller 22. The side coil units 27b are arranged to both sides of the center coil unit 27a. The heat roller 22 is heated across its total length of 320 mm by the center coil unit 27a and the side coil units 27b. The center coil unit 27a and the side coil units 27b may be switched alternately to output or may output at the same time.

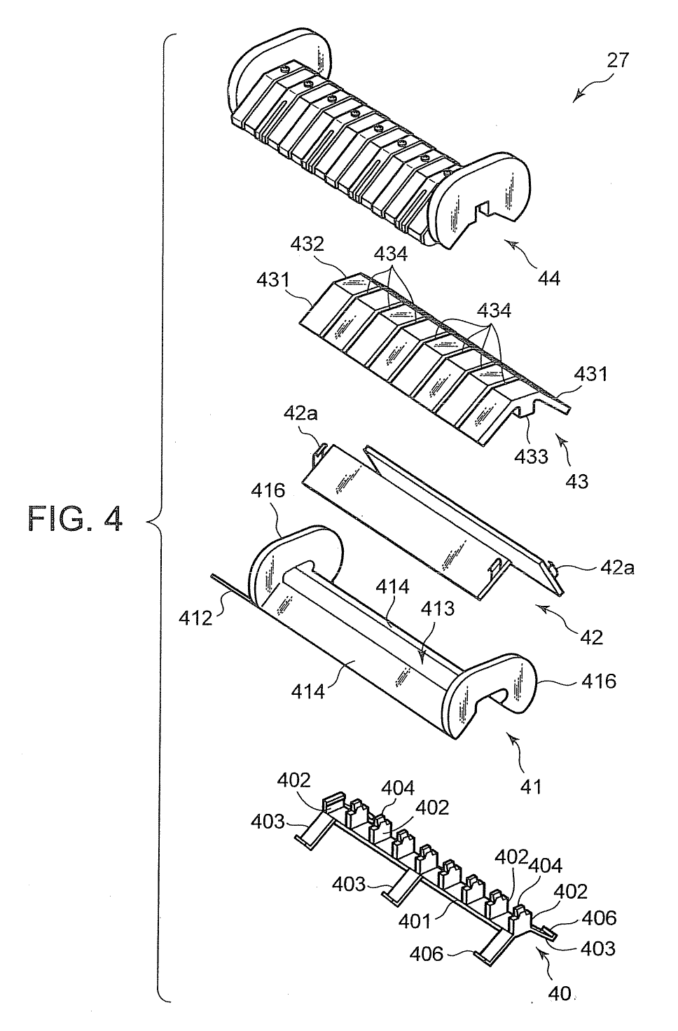

Although the center coil unit 27a and the side coil units 27b differ in length, they have the same configuration and therefore the configuration will be described as a common coil unit 27. As shown in FIG. 4 and FIG. 5, the coil unit 27 has a coil holder 40 as a positioning holder, a winding-shaped electromagnetic induction coil 41 as a coil, an insulating board 42 as an insulating member, a magnetic core 43, and a coil mold 44 as a fixing member.

The electromagnetic induction coil 41 uses, as an electric wire, a Litz wire 412 with a diameter of about 2.5 to 2.6 mm formed by twisting, for example, a bundle of 19 copper wires with a diameter of 0.5 mm. When it is formed, the electromagnetic induction coil 41 is in the shape of a winding formed by winding a single Litz wire 412 on an arbitrary elongated shaping stand. As the electromagnetic induction coil 41 is removed from the shaping stand after it is formed, an elongated coil hole 413 is provided in the part corresponding to the shaping stand. A coil center part 414 of the electromagnetic induction coil 41 is wound parallel to the longitudinal direction of the coil hole 413. Coil edge parts 416 of the electromagnetic induction coil 41, which are parallel to the direction of the shorter side of the coil hole 413, are wound to rise up perpendicularly to the coil center part 414 and have a fan shape.

Heat-resistant polyamideimide is used as an insulating material for the copper wires of the Litz wire. The electric wire and the insulating material are not limited to these and the wire diameter is arbitrary. In the case where such a Litz wire is used, its structure is arbitrary. It may be formed simply by a bundle of plural copper wires, and the number of copper wires and their thickness are not limited, either. Since the use of the Litz wire enables a current to flow through the surface of each copper wire that forms the Litz wire, the current flowing through the electromagnetic induction coil can be used efficiently.

The insulating board 42 is formed by, for example, using a PPS resin (polyphenylene sulfide) having a molding temperature (hardening temperature) of about 280° C. The insulating board 42 has a flat plate-shape covering the coil center part 414 of the electromagnetic induction coil 41 and is formed, for example, to a thickness of about 1.0 mm. The insulating board 42 has a hook part 42a to fix the insulating board 42 to the magnetic core 43 at the time of positioning. The material and shape of the insulating board are not limited. The insulating board does not have to be a PPS resin as long as it can securely insulate the electromagnetic induction coil 41 from the magnetic core 43 in the coil unit 27, and its molding temperature is arbitrary. The thickness of the insulating board is arbitrary, too. However, in order to secure insulation and in order not to lose the magnetic efficiency of the magnetic core, it is preferred that the thickness is within a range of 0.5 to 1.5 mm.

If the thickness of the insulating board 42 is changed to adjust the distance between the electromagnetic induction coil 41 and the magnetic core 43, an induced current flowing through the metal conductive layer 22c of the heat roller 22 can be controlled. That is, as the thickness of the insulating board 42 is controlled, the heating distribution of the metal conductive layer 22c can be adjusted. For example, if the insulating board 42 is made thin in the same coil unit, the heat value of the metal conductive layer 22c can be increased. On the other hand, if the insulating board 42 is made thick, the heat value of the metal conductive layer 22c can be reduced.

The magnetic core 43 concentrates magnetic fluxes of the electromagnetic induction coil 41 to the heat roller 22 and thus improves the magnetic characteristic of the electromagnetic induction coil 41. Therefore, the cross section of the magnetic core 43 is a substantially roof-like shape having core inclination parts 431 inclined on both sides along the coil center part 414 of the electromagnetic induction coil 41. A core flat part 432 at the center of the magnetic core 41 has a core protrusion 433 for positioning, which is supported by the coil holder 40.

The coil holder 40 is made of the same material as the insulating board 42 and is formed by using a PPS resin having a molding temperature of about 280° C. The coil holder 40 has a holder body 401 formed to be elongated corresponding to the shape of the coil hole 413 of the electromagnetic induction coil 41, plural holder bosses 402 provided at predetermined intervals on the holder body 401, and plural holder ribs 403 extending below from the holder body 401.

The plural holder bosses 402 of the coil holder 40 prevent the electromagnetic induction coil 41 from moving in the longitudinal direction, on both sides. Moreover, the holder bosses 402 have their upper-end pawl members 404 fitted in slits 434 provided in the core flat part 432 at the center of the magnetic core 41. The holder ribs 403 get along the inclination of the coil center part 414 of the electromagnetic induction coil 41. As shown in FIG. 5, the holder ribs 403 support the coil center part 414 of the electromagnetic induction coil 41 from below. Also, hooks 406 formed at the ends of the holder ribs 403 support the outer side of the coil center part 414 of the electromagnetic induction coil 41.

The coil holder 40 regulates the electromagnetic induction coil 41 and the magnetic core 43 with the insulating board 42 inserted between the electromagnetic induction coil 41 and the magnetic core 43, thereby positioning the electromagnetic induction coil 41, the insulating board 42 and the magnetic core 43. At this time, the electromagnetic induction coil 41 and the magnetic core 43 are securely insulated by the insulating board 42.

The coil mold 44 is formed as an insulating molding material (resin material) in a liquid state is injected and then hardened and molded. As the molding material, for example, a PPS resin having a molding temperature (hardening temperature) of about 320° C. is used. The molding material is not limited to this, and it may be, for example, a phenol resin, glass-containing resin, carbon, ceramics or the like. A heat-resistant resin is preferred that is not thermally deformed by heat convection due to the heat roller 22.

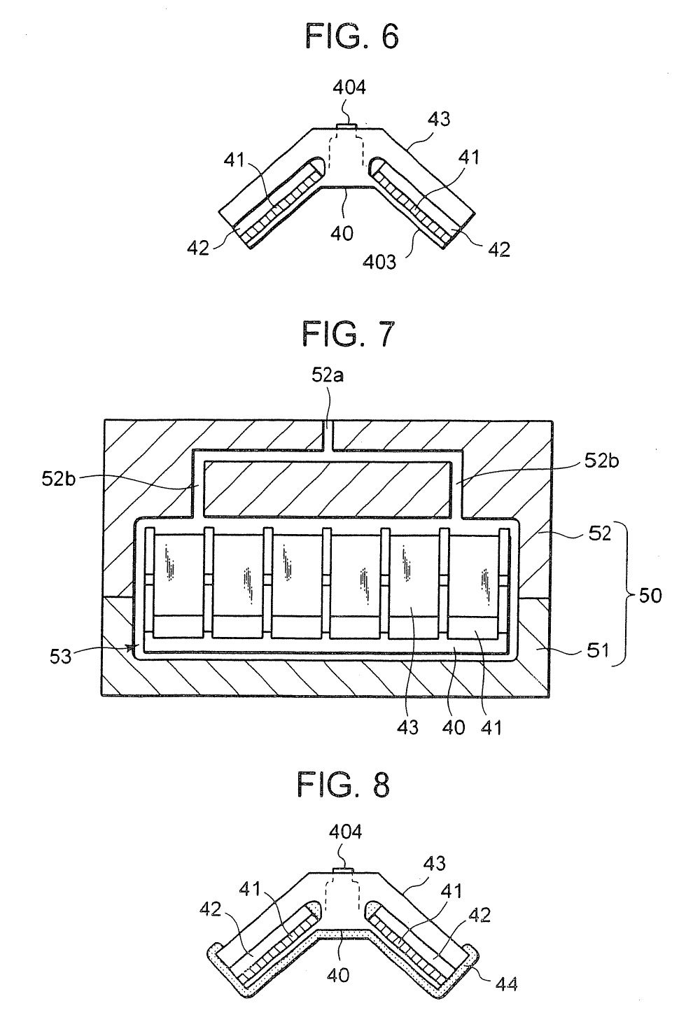

Next, the injection molding of the coil mold 44 will be described. As shown in FIG. 6, the electromagnetic induction coil 41, the insulating board 42 and the magnetic core 43 are positioned (pre-fixed) by the coil holder 40. For positioning, first, the plural holder bosses 402 of the coil holder 40 are inserted into the coil hole 413 of the electromagnetic induction coil 41. Then, the insulating board 42 is arranged on the coil center part 414 of the electromagnetic induction coil 41. Moreover, from above this, the magnetic core 43 is pre-fixed to the coil holder 40. That is, the holder bosses 402 of the coil holder 40 are meshed with the core protrusion 433 of the magnetic core 43. Also, the pawl members 404 of the coil holder 40 are fitted in the slits 434 of the magnetic core 43. Thus, the electromagnetic induction coil 41, the insulating board 42 and the magnetic core 43 are positioned by the coil holder 40, with the insulating board 42 situated between the electromagnetic induction coil 41 and the magnetic core 43.

After that, as shown in FIG. 7, the coil holder 40 having the magnetic induction coil 41, the insulating board 42 and the magnetic core 43 is set within a metal mold 50 for injection molding of the coil mold 44. The metal mold 50 is formed as a first metal mold 51 and a second metal mold 52 are connected with each other. The first metal mold 51 stably sets therein the coil holder 40 having the magnetic induction coil 41, the insulating board 42 and the magnetic core 43. Also, the first metal mold 51 fixes the coil holder 40 to prevent it from moving when a molding material melted into a liquid state, which is the material of the coil mold 44, is injected into the metal mold 50. The second metal mold 52 has an injection port 52a and a flow path 52b to fill the inside with the liquid molding material.

As the coil holder 40 having the magnetic induction coil 41, the insulating board 42 and the magnetic core 43 is set in the first metal mold 51, and the second metal mold 52 is connected thereto (closed), a space 53 corresponding to the shape of the coil mold 44 is formed around the coil holder 40 having the magnetic induction coil 41, the insulating board 42 and the magnetic core 43 in the metal mold 50. Next, the space 53 is filled with the liquid molding material via the flow path 52b from the injection port 52a of the second metal mold 52.

In the metal mold 50, the space 53 around the magnetic induction coil 41, the insulating board 42, the magnetic core 43 and the coil holder 40 is filled with the liquid molding material. At this time, also the space part around the insulating board 42 is filled with the molding material. At the time of filling with the molding material, the molding material generates a flow in a direction of pushing the electromagnetic induction coil 41 from the side of the coil holder 40 toward the magnetic core 43. This flow may deform the electromagnetic induction coil 41 to be offset toward the magnetic core 43. However, since the insulating board 42 exists between the electromagnetic induction coil 41 and the magnetic core 43, there is no risk of contact of the electromagnetic induction coil 41 with the magnetic core 43 even if the electromagnetic induction coil 41 is deformed.

At the time of filling with the molding material, the contacting parts of the coil holder 40 and the insulating board 42 having the molding temperature of about 280° C. with the molding material having the molding temperature of about 320° C., are softened by the heat of the molding material. This improves the adhesiveness between the coil holder 40 and the insulating board 42, and the molding material. When the molding material is cooled to 320° C. or less, the coil mold 44 is molded integrally with the insulating board 42 and the coil holder 40, and is softened. Thus, as shown in FIG. 8, the coil unit 27 is formed in which the magnetic induction coil 41 and the magnetic core 43 are sealed by the coil mold 44.

In this coil unit 27, the electromagnetic induction coil 41 and the magnetic core 43 are securely separated away by 1.0 mm by the existence of the insulating board 42. The thickness of the coil mold 44 covering the side of the electromagnetic induction coil 41 of the coil unit 27 is, for example, about 0.5 mm. Therefore, in this embodiment, since the gap between the heat roller 22 and the coil unit 27 in the fixing device 11 is set to be about 2.5 mm, the practical distance from the surface of the electromagnetic induction coil 41 to the surface of the heat roller 22 is about 3 mm.

When the center coil unit 27a and the side coil units 27b molded in this manner are used for the fixing device 11 and high-frequency power is supplied to the electromagnetic induction coil 41 in order to generate heat in the heat roller 22, the electromagnetic induction coil 41 is prevented from oscillating because it is fixed by the coil mold 44. Therefore, the positional relation between the electromagnetic induction coil 41 and the metal conductive layer 22c of the heat roller 22 is kept constant and the heat roller 22 can gain a predetermined heating temperature across its total length.

According to this embodiment, in order to fix the electromagnetic induction coil 41 by the molding material, the electromagnetic induction coil 41 and the magnetic core 43 with the insulating board 42 arranged between them, are positioned by the coil holder 40 at the time of injection molding of the coil mold 44. Thus, when the liquid molding material is injected into the space 53 in the metal mold 50, the insulation between the electromagnetic induction coil 41 and the magnetic core 43 can be securely maintained even if the electromagnetic induction coil 41 is pushed toward the magnetic core 43 and deformed by the flow of the molding material. Therefore, no defective products are generated due to insulation failure between the electromagnetic induction coil 41 and the magnetic core 43 at the time of injection molding of the coil mold 44, and the manufacturing yield of the coil unit is improved.

Next, a second embodiment of the invention will be described. In this second embodiment, heat generation distribution of the heat roller is adjusted by using plural coil units in which the shape or thickness of the insulating board is controlled in the above first embodiment. The other parts are similar to the first embodiment. Therefore, the same configuration as the configuration described in the above first embodiment is denoted by the same reference numerals and will not be described further in detail.

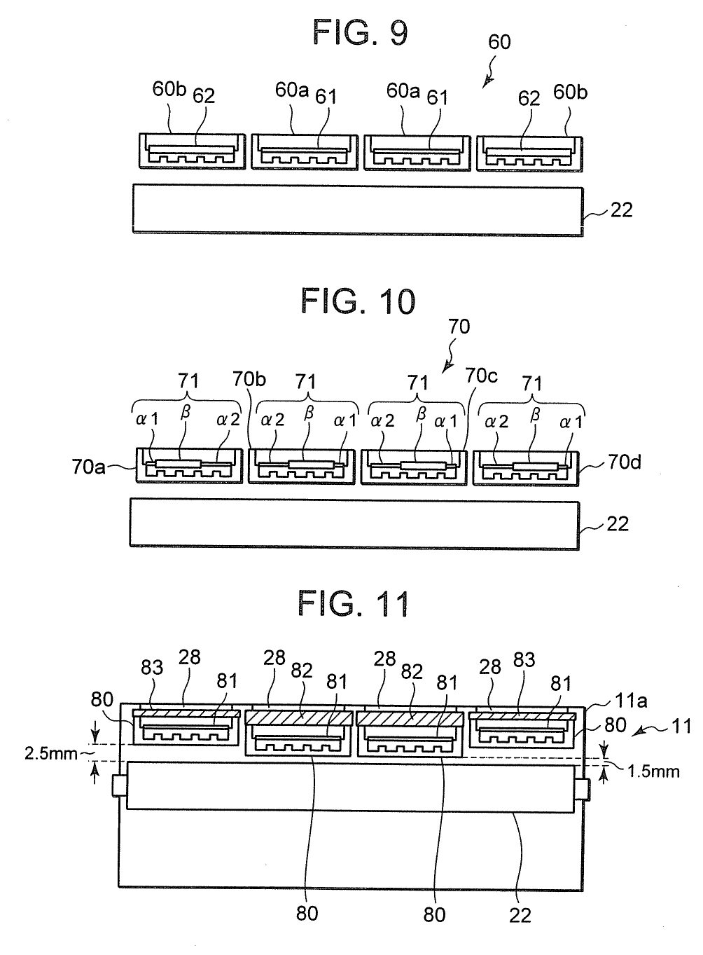

In the second embodiment, as shown in FIG. 9, the heat roller 22 is heated across the total length by using four coil units 60 of the same length. These four coil units 60 are different in the thickness of insulating boards 61 and 62, but all the other parts have the same structure. The insulating boards 62 of side coil units 60b on both lateral sides that generate heat in the side areas of the heat roller 22, where the frequency of passage of the sheet paper P is low, are thicker than the insulating boards 61 of the two center coil units 60a that generate heat in the center area of the heat roller 22, where the frequency of passage of the sheet paper P is high. For example, the insulating boards 61 of the center coil units 60a are formed to a thickness of 0.5 mm. The insulating boards 62 of the side coil units 60b are formed to a thickness of 1.5 mm.

The center coil units 60a and the side coil units 60b use common components for the components except the insulating boards 61 and 62, that is, the coil holder 40, the electromagnetic induction coil 41 and the magnetic core 43. Also, in the center coil units 60a and the side coil units 60b, the coil mold 44 sealing the electromagnetic induction coil 41 and the magnetic core 43 is injection-molded in a similar manner to the above embodiment, using the common metal mold 50.

In the center coil unit 60a, the insulating board 61 is as thin as 0.5 mm and the distance between the electromagnetic induction coil 41 and the magnetic core 43 is short. Therefore, the magnetism of the magnetic core 43 effectively acts at the time of driving the electromagnetic induction coil 41 to which a high frequency is applied. On the other hand, in the side coil unit 60b, the insulating board 62 is as thick as 1.5 mm and the distance between the electromagnetic induction coil 41 and the magnetic core 43 is long. Therefore, the magnetic efficiency of the magnetic core 43 at the time of driving the electromagnetic induction coil 41 to which a high frequency is applied, is lowered.

Thus, even when the same current is caused to flow through the electromagnetic induction coils 41 of the center coil units 60a and of the side coil units 60b, magnetic fluxes can be concentrated more efficiently to the metal conductive layer 22c of the heat roller 22 in the center coil units 60a than in the side coil units 60b. That is, with the same current, the temperature of the center area of the heat roller 22 heated by the induced current of the center coil units 60a is higher than the temperature of the side areas of the heat roller 22 heated by the induced current of the side coil units 60b. As a result, with the same current, it is possible to adjust the temperature of the center area of the heat roller 22 where the frequency of passage of the sheet paper P is high and the temperature of the side areas of the heat roller 22 where the frequency of passage of the sheet paper P is low.

In the case where the heat roller 22 is heated across the total length by using plural coil units of the same lengths, the number of coil units is not limited to four. The thickness of the insulating boards used in the plural coil units is not limited, either.

According to this embodiment, as in the above first embodiment, there are no defective products due to insulation failure between the electromagnetic induction coil 41 and the magnetic core 43 at the time of injection-molding of the coil mold 44, and the manufacturing yield of the coil unit is improved. Also, according to this embodiment, the heat generating temperature of the heat roller can be easily adjusted simply by a change in the thickness of the insulating boards of the coil units. Moreover, according to this embodiment, the plural coil units having different magnetic characteristics for heating the heat roller 22 across the total length can be sealed by a common metal mold with common components. Thus, the coil units used in various kinds of fixing devices can be shared and the productivity of the fixing device can be improved. As such coil units are used, a fixing device can be provided in which temperature control and reduction in the manufacturing cost can be achieved.

Next, a third embodiment of the invention will be described. This third embodiment differs from the above second embodiment in the pattern of insulating boards. Since the other parts are similar to the second embodiment, the same configuration as the configuration described in the above second embodiment are denoted by the same reference numerals and will not be described further in detail.

In the third embodiment, as shown in FIG. 10, four identical coil units 70 are arranged next to each other and to face the heat roller 22. However, an insulating board 71 of the coil unit 70 is patterned to have thin areas α1 and α2 at both ends and a thick area β in the center. Moreover, in the coil units 70a and 70d on both sides of the heat roller 22, the pattern of the thin areas and thick area of the insulating board 71 is symmetrically arranged. That is, in the coil units 70a and 70d, the thin area α1 of the insulating board 71 is situated on the outer side and the thin area α2 is situated towards the center. Meanwhile, in the coil units 70b and 70c in the center of the heat roller 22, the pattern of the thin areas and the thick area of the insulating board 71 is in the same direction. That is, in the coil units 70b and 70c, the thin area α1 of the insulating board 71 is situated towards the right side of FIG. 10 and the thin area α2 is situated towards the left side of FIG. 10.

This is formed as the coil units 70b, 70c and 70d are arranged in the same direction while the coil unit 70a is arranged in the opposite direction in FIG. 10. The thin areas α1 and α2 in the coil unit 70 are formed to, for example, a thickness of 0.5 mm. On the other hand, the thick area β in the coil unit 70 is formed to, for example, a thickness of 1.5 mm. Therefore, the distance between the electromagnetic induction coil 41 and the magnetic core 43 changes in the coil unit 70.

In the areas α1 and α2 of the coil unit 70, where the insulating board is thin, since the distance between the electromagnetic induction coil 41 and the magnetic core 43 is short, the magnetism of the magnetic core 43 effectively acts at the time of driving the electromagnetic induction coil 41. On the other hand, in the area β, where the insulating board is thick, since the distance between the electromagnetic induction coil 41 and the magnetic core 43 is long, the magnetic efficiency of the magnetic core 43 at the time of driving the electromagnetic induction coil 41 is lowered.

Thus, the temperature of the heat roller 22 corresponding to the area α1 and the area α2 in the coil unit 70 is higher than the temperature of the heat roller 22 corresponding to the area β. As four of these coils 70 are arranged as shown in FIG. 10, the temperature drop that occurs between the plural coil units 70a to 70d or the temperature drop that occurs at both ends of the heat roller 22 can be compensated for. Moreover, near the center of the heat roller 22, the area α1, the area α2 and the area β are arranged in good balance and therefore the temperature can be made even in the longitudinal direction of the heat roller 22.

The pattern of the thin areas and the thick area of the insulating board and the thickness of each area are not limited to this embodiment. For example, it is possible to make both ends of the insulating board thick and to make a required part thin in order to adjust temperature variance across the total length of the heat roller. Also, if plural patterns of insulating boards are prepared instead of one pattern, the temperature distribution of the heat roller can be adjusted more minutely. Moreover, in the coil unit, the insulating board may have an inclination in order to adjust the temperature of the heat roller. By doing so, it is possible to make stepless adjustment of the heat generation distribution of the heat roller by the coil unit.

According to this embodiment, as in the above second embodiment, there are no defective products due to insulation failure between the electromagnetic induction coil 41 and the magnetic core 43 at the time of injection-molding of the coil mold 44, and the manufacturing yield of the coil unit is improved. Also, according to this embodiment, since the same coil units are used and the pattern of thickness of the insulating board is suitably arranged in accordance with the area of the coil unit, the heat generation temperature of the heat roller can easily be adjusted. Since the coils used are of one kind, the productivity of the coil unit can be improved. As such coil units are used, a fixing device can be provided in which temperature control and reduction in the manufacturing cost can be achieved.

Next, a fourth embodiment of the invention will be described. In this fourth embodiment, the gap between the plural coil units and the heat roller in the above first embodiment is adjusted and the heat generation distribution of the heat roller is thus adjusted. The other parts are similar to the first embodiment. Therefore, the same configuration as the configuration described in the above first embodiment is denoted by the same reference numerals and will not be described further in detail.

In the fourth embodiment, as shown in FIG. 11, four coil units 80 of the same type having a 0.5-mm thick insulating board 81 are arranged to heat the heat roller 22 across the total length. However, the two ones in the center, of the four coil units 80, are attached to attachment parts 28 via thin coil gap adjustors 82 having a thickness of, for example, 1 mm, which are position adjusting members. Also, the two ones on the sides are attached to attachment parts 28 via thick coil gap adjustors 83 having a thickness of, for example, 2 mm, which are position adjusting members.

Thus, the gap between the coil unit 80 and the heat roller 22 in the center is set to be, for example, about 1.5 mm. Also, the gap between the coil unit 80 in the side area and the heat roller 22 is set to be, for example, about 2.5 mm. In the center, the gap is small and the electromagnetic induction coil 41 is close to the heat roller 22. Therefore, a large amount of induced current is generated in the metal conductive layer 22c and the heat roller 22 acquires high heat generation. On the other hand, in the side areas, the gap is large and a small amount of induced current is generated in the metal conductive layer 22c. The heat generation of the heat roller 22 is lower than in the center.

Therefore, even if the same current is provided to the four identical coil units 80 arranged to face the heat roller 22, the heat generation temperature in the center area of the heat roller 22 can be made higher than that in the side areas. That is, even when the same coil units 80 are used and the same current is caused to flow, the temperature can be adjusted in the center area of the heat roller 22, where the frequency of passage of the sheet paper P is high, and the side areas of the heat roller 22, where the frequency of passage of the sheet paper P is low.

According to this embodiment, as in the above first embodiment, there are no defective products due to insulation failure between the electromagnetic induction coil 41 and the magnetic core 43 at the time of injection-molding of the coil mold 44, and the manufacturing yield of the coil unit is improved. Also, according to this embodiment, even when the same coil units 80 are used, the heat generating temperature of the heat roller can be easily adjusted by the change in the thickness of the gap adjustors 82 and 83. Moreover, according to this embodiment, the plural coil units to heat the heat roller 22 across the total length can be identical. Along with this, the coil units used for various kinds of fixing devices can be shared and the productivity of the fixing device can be improved. As such coil units are used, a fixing device can be provided in which temperature control and reduction in the manufacturing cost can be achieved.

This invention is not limited to the above embodiments and various changes can be made within the scope of the invention. For example, the endless heating target member may be a fixing belt, and the shape and the like of the electromagnetic induction coil and the magnetic core is arbitrary. Also, the material, shape or size of the insulating member inserted between the winding coil and the magnetic core is not limited, either, as long as it can prevent contact between the winding coil and the magnetic core. Its molding temperature is arbitrary, too, but if a material having a lower molding temperature than the fixing member is used, the contact part softens at the time of injection-molding of the fixing member and the adhesiveness between them can be improved. Moreover, if the position of the insulating member with respect to the winding coil and the magnetic core can be specified when it is positioned by the positioning holder, the hook part to fix the insulating member to the magnetic core needs not be provided. The shape and thickness of the fixing member is arbitrary, too, and it may cover up to the top surface of the magnetic core.

What is claimed is:

1. A coil unit comprising:
a coil;
a magnetic core arranged with a predetermined space to the coil;
an insulating member inserted into the predetermined space between the coil and the magnetic core;
a positioning holder configured to position the coil, the insulating member and the magnetic core; and
a fixing member configured to harden after being molded in a liquid state and to fix the coil, the insulating member and the magnetic core, which are positioned, together with the positioning holder.

2. The coil unit according to claim 1, wherein the fixing member hardens integrally with the coil, the magnetic core, the insulating member and the positioning holder.

3. The coil unit according to claim 1, wherein the molding temperature of the insulating member is lower than the molding temperature of the fixing member.

4. The coil unit according to claim 1, wherein the insulating member is an insulating board.

5. The coil unit according to claim 4, wherein the thickness of the insulating board is not uniform and has a step.

6. The coil unit according to claim 4, wherein the thickness of the insulating board is not uniform and has an inclination.

7. The coil unit according to claim 1, wherein the insulating member has a hook part, and the insulating member is attached to the magnetic core by the hook part.

8. A fixing device comprising:
a heating target member having a metal conductive layer;
a coil unit arranged over an outer circumference of the heating target member and having a coil, a magnetic core arranged with a predetermined space to the coil, an insulating member inserted into the predetermined space between the coil and the magnetic core, a positioning holder configured to position the coil, the insulating member and the magnetic core, and a fixing member configured to harden after being molded in a liquid state and to fix the coil, the insulating member and the magnetic core, which are positioned, together with the positioning holder; and
a pressurizing member configured to be pressed in contact with the heating target member and to nip and carry a fixing target medium into a predetermined direction together with the heating target member.

9. The fixing device according to claim 8, wherein a plural number of the coil units are arranged in the direction of a rotation axis of the heating target member.

10. The fixing device according to claim 9, wherein the plural coil units are the same coil units.

11. The fixing device according to claim 10, wherein a gap between the plural coil units and the heating target member is set for each of the coil units.

12. The fixing device according to claim 11, further comprising:
a frame configured to support the plural coil units; and
a position adjusting member provided between the coil units and the frame and having a thickness corresponding to the gap.

13. The fixing device according to claim 8, wherein the insulating members of the plural coil units are not of a single kind.

14. The fixing device according to claim 8, wherein the fixing member hardens integrally with the coil, the magnetic core, the insulating member and the positioning holder.

15. The fixing device according to claim 8, wherein the molding temperature of the insulating member is lower than the molding temperature of the fixing member.

16. The fixing device according to claim 8, wherein the insulating member is an insulating board.

17. The fixing device according to claim 16, wherein the thickness of the insulating board is not uniform and has a step.

18. The fixing device according to claim 16, wherein the thickness of the insulating board is not uniform and has a step.

19. The fixing device according to claim 16, wherein the thickness of the insulating board has an inclination.

20. A method for manufacturing of a coil unit comprising:
inserting an insulating member between a coil and a magnetic core and attaching the coil and the magnetic core to a positioning holder;
setting the coil, the insulating member, the magnetic core and the positioning holder in a metal mold; and
injecting a molding material into a space of the metal mold and sealing the coil and the magnetic core.
